(19) United States
(12) Patent Application Publication
(10) Pub. No.: US 2019/0106094 A1
(43) Pub. Date: Apr. 11, 2019

(54) Braking System for a Wheeled Vehicle

(71) Applicant: Wacker Neuson Linz GmbH, Horsching (AT)

(72) Inventors: Dieter Farthofer, Ansfelden (AT); Stephen Mahringer, Sankt Martin Im Muehlkreis (AT)

(73) Assignee: Wacker Neuson Linz GmbH

(21) Appl. No.: 16/156,028

(22) Filed: Oct. 10, 2018

(30) Foreign Application Priority Data
Oct. 10, 2017 (DE) 10 2017 123 497.7

(51) Int. Cl. B60T 13/58; B60T 11/20; B60T 13/22; B60K 17/346

(52) U.S. Cl. CPC B60T 13/58; B60T 11/20; B60T 2270/402; B60K 17/346; B60T 13/22

(57) ABSTRACT

A braking system for a vehicle includes two meterable metering brake circuits and a non-meterable parking brake circuit. Each of the two metering brake circuits has a metering brake device which is assignable to a wheel of the vehicle. The two metering brake circuits have a common metering operating device, with which the two metering brake devices are operable simultaneously. The metering operating device has a tandem brake cylinder, with two chambers which are each part of one of the metering brake circuits. The parking brake circuit has two parking brake devices, which are each assignable to a respective wheel of the vehicle. The parking brake circuit has a parking operating device with which the two parking brake devices are operable simultaneously.

### BACKGROUND OF THE INVENTION

### 1. Field of the Invention The invention relates to a braking system for an, for example, two-axle wheeled vehicle.

2. Description of the Related Art

Vehicles which have two axles, of which, however, only one axle is brakeable, while the wheels of the other axle can move freely, are known in the construction sector. The braking system for the brakeable axle customarily has a meterable foot brake in combination with a meterable hand brake. The meterability of the hand brake is a specification of the German Road Traffic Licensing Regulations (StVZO), and therefore the hand brake can serve an auxiliary braking system, Both the service braking system in the form of a foot brake and the auxiliary braking system in the form of a hand brake in each case act on the left and the right wheel of the braked axle.

FIG. 1 shows an example of a braking system of this type.

The braking system is part of a vehicle having an unbraked rear axle I and a braked front axle 2. The axles 1, 2 are driven simultaneously via a drive shaft 3, a distribution transmission 4 and a cardan shaft 5. Wheels (not illustrated) which are fastenable to hubs 7 are in each case mountable on the face-side ends of the rear axle 1 and of the front axle 2.

Parts of the braking system having a foot brake 8 and a parking brake or hand brake 9 are provided on the front axle 2. Both the foot brake 8 and the hand brake 9 are meterable. This means that the action of the braking force can be adjusted depending on the actuating force applied by the operator and the available pedal travel.

The braking pressure generated by a main brake cylinder 11, which is coupled to the brake pedal 10, is more powerful the harder the operator steps on a brake pedal 10 of the foot brake 8. Said braking pressure in the brake fluid is transmitted to two brake devices 12 which are each assigned on the front axle 2 to the left wheel and to the right wheel. The operator can thus vary the braking action in a known manner by actuating the brake pedal 10.

The hand brake 9 also acts in an analogous manner. The braking pressure, which is supplied at two parking brakes 15 on the left and the right wheel of the front axle 2, can also be metered there via a manually actuable brake lever 13 and a suitable control valve 14.

A first pressure sensor 16 is provided in the brake circuit of the foot brake 8, and a second pressure sensor 17 is provided in the brake circuit of the hand brake 9, The two independent brake circuits 8, 9 can be monitored with the aid of the pressure sensors 16, 17. They firstly permit co-ordination of the entire braking system during assembly at the factory and secondly monitoring during operation.

The construction of such a meterable hand brake is complicated and costly. However, it essentially has to be provided in order to meet the StVZO regulations in respect of two meterable brake circuits.

### SUMMARY OF THE INVENTION

The invention is based on the object of specifying a braking system for a vehicle, in which the outlay on providing a meterable hand brake can be avoided, but the StVZO regulations can nevertheless be adhered to.

The object is achieved according to the invention by providing a braking for a vehicle that has two meterable metering brake circuits and a non-meterable parking brake circuit. Each of the two metering brake circuits has at least one metering brake device, which is assignable to a wheel of the vehicle. The two metering brake circuits have a common metering operating device, with which the two metering brake devices are operable simultaneously, The metering operating device has a tandem brake cylinder, with two chambers which are each part of one of the metering brake circuits. The parking brake circuit has two parking brake devices, which are each assignable to a wheel of the vehicle, and the parking brake circuit has a parking operating device with which the two parking brake devices are operable simultaneously.

The two meterable metering brake circuits can therefore also be understood as meaning, for example, a foot brake and can be jointly and simultaneously operated, for example by means of a foot pedal. “Metering” means here that the braking force or braking action of the respective metering brake device is adjustable variably, for example depending on the force with which an operator acts with his foot on the brake pedal.

In addition to the two metering brake circuits which are actuable by the common metering operating device, the non-meterable parking brake circuit is provided, “Non-meterable” means in this case that the braking force cannot be varied, i.e. metered, as desired. On the contrary, the braking force can only be adjusted between, for example, two positions, namely OFF and ON i.e. “no braking pressure” or “full braking pressure”. Within this context, the parking brake circuit can either release the rotation of the assigned wheels or prevent same by the corresponding braking action. Variable intermediate positions, in order also to achieve a gentle deceleration of the vehicle, are not possible with the parking brake circuit.

The parking brake circuit can be formed hydraulically or else purely mechanically, without hydraulic components. The term “brake circuit” should therefore be understood broadly in this connection. The parking brake circuit therefore does not have to have hydraulic components. On the contrary, in an alternative embodiment, said parking brake circuit can operate with exclusively mechanical components.

As will also be explained below, the parking brake device can be configured, for example, as a spring-loaded brake or the like. This means that the parking brake device deploys its full braking action in the switched-off, i.e. unpressurized state. Only in the switched-on state, with corresponding braking pressure, can the braking action be canceled and therefore the rotation of the assigned wheel released. It can thereby be ensured that the parking braking action is reliably provided even if no braking pressure can be built up.

The construction of a tandem brake cylinder is known per se. The tandem brake cylinder has two chambers which are each assigned to one of the metering brake circuits and contain brake fluid of the respective metering brake circuit. The chambers are separated from each other by a floating piston, i.e. a piston which is movable in both directions. This has the effect that the pressure increase in one chamber is also directly transmitted by the floating piston to the other chamber, and therefore the hydraulic pressure in the two chambers and therefore in the two metering brake circuits is always identical. A uniform braking action can thereby be achieved. The actual braking force is introduced by a further piston which can be actuated by a foot or brake pedal and which acts on one of the two chambers.

In the event of failure of one of the two metering brake circuits, the pedal travel is doubled because of the operation of the tandem brake cylinder if a brake pedal is used as part of the metering operating device. The operator thereby receives feedback that there is an error in the braking system. The metering brake circuits can therefore be reliably actuated as before and can carry out their function. However, the operator recognizes on the basis of the increased pedal travel that the brake has to be checked.

With the provision of two meterable metering brake circuits, the StVZO requirement, according to which two meterable brake circuits have to be provided, is already met.

The parking brake designed in the prior art as a meterable hand brake now no longer has to be meterable, which is realized by means of the non-meterable parking brake circuit.

The parking brake circuit has a suitable parking operating device, for example a hand lever or a toggle switch, with which the two parking brake devices are operable simultaneously. It suffices for the parking operating device to provide just two switching states, “on” or “off” (corresponding to a release of the wheels).

A branch to the two parking brake devices can be provided in the parking brake circuit. With the aid of the branch, the braking pressure released via the parking operating device is therefore uniformly distributed to the two parking brake devices in order to activate or to release same.

The parking brake devices can be constructed in particular in such a manner that they reliably brake the respectively assigned wheel in an inoperative state, i.e. in an unpressurized state without braking pressure. Only in an operating state in which an appropriate hydraulic pressure is built up in the parking brake circuit can the holding force of the brake be overcome and the brake released so that the assigned wheel can freely rotate.

In each case one metering brake device and one parking brake device can be assignable to the same wheel of the vehicle. The two different types of brake device can therefore be provided on each wheel or on the hub belonging thereto.

A suitable brake device is, for example, a friction brake with a brake cylinder and a disk pack. If the metering brake device and the parking brake device are assigned to the same wheel (or to the same hub) of the vehicle, they can also have a common brake disk pack, on which, however, different pistons assigned to the respective brake devices act.

All of the brake devices can be arrangeable on a common axle of the vehicle. The said axle is then also referred to as a “braked axle”, while the other axle of the vehicle, on which no brake devices are provided, is an “unbraked axle”.

The parking brake devices can be in the form of a spring-loaded brake. The spring-loaded brake here can have a spring-loaded brake piston which, in the event of a pressure build up in the parking brake circuit, is liftable off the brake disk pack, and which, in a zero-pressure situation in the parking brake circuit, acts against the brake disk pack because of the spring loading, This means that the braking force acts at a standstill or in the switched-off (unpressurized) state and prevents rotation of the assigned wheel. Only upon a pressure build-up in the parking brake circuit is the braking pressure guided via the abovementioned branch. to the two parking brake devices and reverses the piston there counter to the action of the respective springs such that the braking state is canceled.

A pressure limiting valve can be provided in each of the metering brake circuits. It is therefore possible to limit the maximum braking force.

A throttle non-return valve can in each case be provided in the parking brake circuit. The application speed of the parking brake can therefore be reduced in order to avoid abrupt braking after actuation of the parking operating device. Conversely, the parking brake can be released very rapidly and without a time delay,

The parking operating device can be in the form in particular of a binary switching device. The parking brake can thus be activated, for example, electronically (switch, button) or mechanically (lever). A non-meterable hydraulic valve, which is only switchable between two positions, can also be provided.

A working vehicle is specified, comprising two axles, on which in each case one left wheel and a right wheel are arranged rotatably on the assigned axle, wherein one of the axles is a brakeable axle, on which at least one brake device is arranged, wherein the other axle is a freely rotatable axle, on which no brake device is arranged, and wherein the brake device is part of a braking system as described above.

A suitable working vehicle is in particular a construction vehicle, such as, for example, a skip vehicle, a dumper or an earth mover.

These and further advantages and features will be explained in more detail below using an example with reference to the figures, in which

### BRIEF DESCRIPTION OF THE DRAWINGS

FIG. 1 shows a braking system known from the prior art; and

FIG. 2 shows a braking system according to the invention.

### DETAILED DESCRIPTION OF THE PREFERRED EMBODIMENT

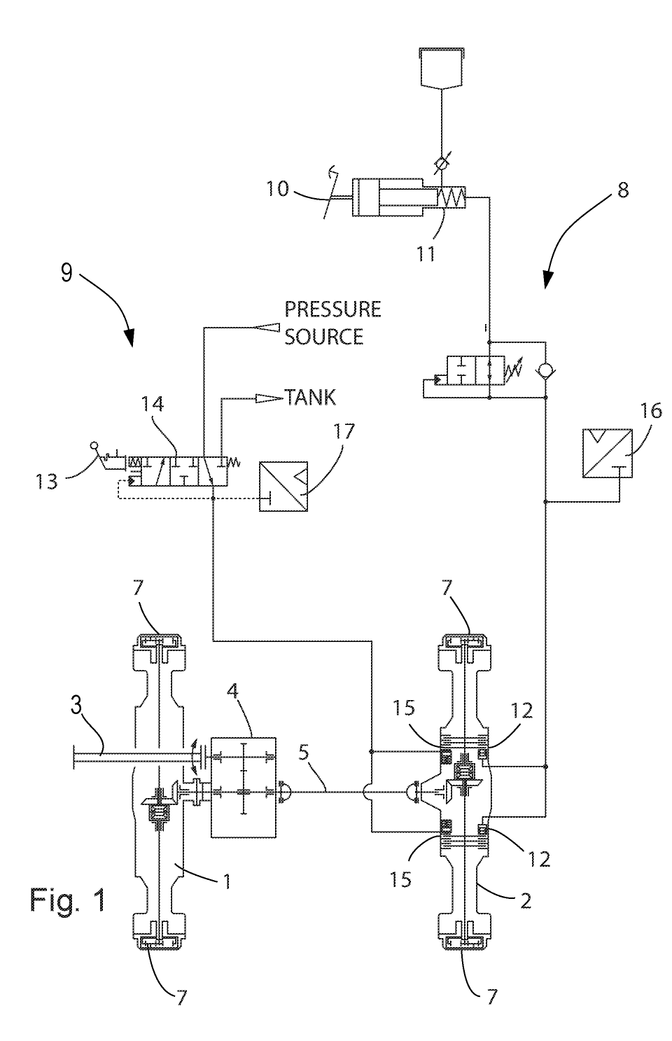

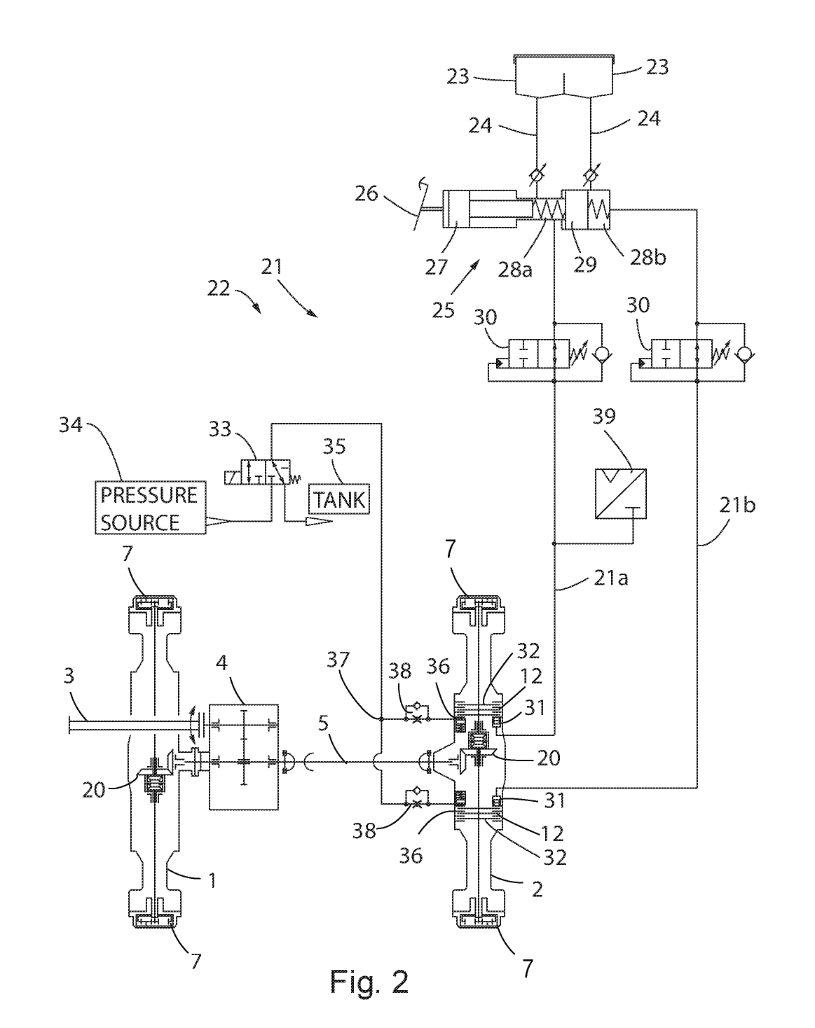

FIG. 2 schematically illustrates a vehicle, the mechanical design of which corresponds to the vehicle of FIG. 1. The vehicle thus has a rear axle 1 and a front axle 2. The motor power is distributed via a drive shaft 3, a distribution transmission 4 and cardan shaft 5 to the two axles 1, 2. Rotatably mounted hubs 7, on which corresponding wheels (not illustrated) can be fastened, are arranged at the respective ends of the axles 1, 2.

Analogously to the vehicle of FIG. 1, also in the case of the vehicle of FIG. 2 only the front axle 2 is brakeable, while the rear axle 1 freely rotates at the same time. For this purpose, a brake device 12 is provided on each hub 7 of the front axle 2.

Each of the axles 1, 2 has a differential transmission 20 in order to decouple the two wheels of the axle from each other.

Therefore, if one of the brake devices 12 on the front axle 2 fails, the brake device 12 of the other wheel takes over the braking of the vehicle. The braking torque is then also transmitted by means of the cardan shaft 5 to the other axle (rear axle 1), and therefore, although the (still functional) brake is only positioned on one wheel, it acts indirectly on all four wheels via the cardan shaft 5 and the differential transmission 20.

For the activation of the brake devices 12, separate systems are provided, namely two meterable metering brake circuits 21 (or 21a, 21b) and a non-meterable parking brake circuit 22.

The metering brake circuits 21 are illustrated in FIG. 2 as a left metering brake circuit 21a (for the left wheel or the left hub 7 of the front axle 2) and a right metering brake circuit 21b (analogously for the right wheel or the right hub 7 of the front axle 2).

Each of the metering brake circuits 21 has an equalizing container 23 for brake fluid which is in each case conducted via a dedicated line 24 to a common tandem brake cylinder 25. The tandem brake cylinder 25 is coupled to a foot pedal 26 via which the operator can exert a compressive force on a piston 27.

The tandem brake cylinder 25 has two chambers 28a (for the left metering brake circuit 21a) and 28b (for the right metering brake circuit 21b). The chambers 28a, 28b are separated from each other by a floating piston 29. The floating piston 29 ensures that the same hydraulic pressure always prevails in the two chambers 28a, 28b. Possibly occurring pressure differences are directly equalized by shifting of the floating piston 29. It can thereby be achieved that a standard, uniform braking action is obtained by the two separate metering brake circuits 21.

A pressure limiting valve 30 is provided in each of the metering brake circuits 21a, 21b in order to limit the maximum pressure. Damage to the brake is thereby intended to be avoided.

The metering brake circuits 21a, 21b each lead to the brake device 12 assigned thereto and act there upon one (or more) pistons 31.

The braking pressure is metered by the operator by actuation of the foot pedal 26. The pressure in the chambers 28a, 28b is higher the more powerfully the operator presses on the foot pedal 26, and therefore the brake pistons 31 are correspondingly likewise acted upon with increased pressure and pressed against an assigned disk pack 32.

The parking brake circuit 22 has a switching device 33 serving as a parking operating device. The switching device 33 can be an electric button or switch or else a hydraulic or mechanical lever or switch. The switching device 33 serves to conduct pressure from a pressure supply 34 belonging to the vehicle to the brake (also explained below) or to remove the pressure in the brake fluid to a tank 35.

The parking brake circuit 22 in each case includes a spring-loaded brake 36 which is assigned to the corresponding brake device 12 and therefore hub 7. The spring-loaded brake 36 has a piston which is pressed in a spring-loaded manner against the disk pack 32. Only in the event of pressurization via the parking brake circuit 22 and correspondingly present pressure supply 34 is the piston in the spring-loaded brake 36 lifted off the disk pack 32 and thus releases the rotation.

A branch 37 is provided for the uniform distribution of the braking pressure in the parking brake circuit 32.

A throttle non-return valve 38 is each case provided between the branch 37 and the respective spring-loaded brake 36, The throttle non-return valve 38 on account of its throttling action prevents too rapid a pressure drop in the parking brake circuit 22 when the pressure supply 34 is interrupted or the brake line to the tank 35 is opened. As a result, it is possible not to carry out the braking operation abruptly, but in a somewhat delayed manner in order to avoid sudden braking of the vehicle and to ensure stability in all operating states. This can be comfortable in particular whenever the vehicle is still moving slowly while the driver has already activated the parking brake.

In a reverse direction of flow, the non-return valve in the throttle non-return valve 38 is opened, and therefore, when the brake is released, the brake (spring-loaded brake 36) can be immediately acted upon with braking pressure and therefore released.

A pressure sensor 39 is provided in one of the metering brake circuits 21a, 21b (in the left metering brake circuit 21a in the example shown in FIG. 2) in order to monitor the braking pressure, On account of the interaction of the two metering brake circuits 21a, 21b via the tandem brake cylinder 25, only one pressure sensor 39 is required. A further pressure sensor, e.g. in the parking brake circuit 22, is not required. By contrast, in the prior art explained in conjunction with FIG. 1, two pressure sensors 16, 17 have to be provided. The pressure sensor 39 serves firstly for coordinating the braking system at the factory and secondly for monitoring during operation.

The design according to the invention of a braking system that is shown in FIG. 2 therefore differs from the prior art braking system shown in FIG. 1 in particular in that, although three brake circuits (2 brake circuits in the prior art in FIG. 1) are now assembled, they permit a simpler design. By means of the use of the tandem brake cylinder 25 and of the two meterable metering brake circuits 21 (foot brake), the StVZO regulations are met. The hand brake or parking brake formed in a non-meterable manner as the parking brake circuit 22 can therefore be constructed more simply.

What is claimed is:

1. A braking system for a vehicle, comprising:
two meterable metering brake circuits; and
a non-meterable parking brake circuit, wherein
each of two metering brake circuits has a metering brake device which is assignable to a wheel of the vehicle;
the two metering brake circuits have a common metering operating device, with which the two metering brake devices are operable simultaneously;
the metering operating device has a tandem brake cylinder, with two chambers which are each part of one of the metering brake circuits;
the parking brake circuit has two parking brake devices, which are each assignable to a wheel of the vehicle; and wherein
the parking brake circuit has a parking operating device with which the two parking brake devices are operable simultaneously.

2. The braking system as claimed in claim 1, wherein the two chambers of the tandem brake cylinder are separated from each other by a floating piston.

3. The braking system as claimed in claim 1, wherein a branch to the two parking brake devices is provided in the parking brake circuit.

4. The braking system as claimed in claim 1, wherein, in each case, one metering brake device and one parking brake device are assignable to the same wheel of the vehicle.

5. The braking system as claimed in claim 1, wherein all of the brake devices are arrangeable on a common axle of the vehicle.

6. The braking system as claimed in claim 1, wherein each of the parking brake devices comprises a spring-loaded brake,

7. The braking system as claimed in claim 6, wherein the spring--loaded brake has a spring-loaded brake piston which, in the event of a pressure build up in the parking brake circuit, is liftable off a brake disk pack, and which, in the event of a zero-pressure situation in the parking brake circuit, acts against the brake disk pack because of the spring loading.

8. The braking system as claimed in claim I, wherein a pressure limiting valve is provided in each of the metering brake circuits.

9. The braking system as claimed in claim 1, wherein a throttle non-return valve is, in each case, provided in the parking brake circuit.

10. The braking system as claimed in claim 1, wherein the parking operating device comprises a binary switching device.

11. A working vehicle, comprising
two axles, on which, in each case, at least one left wheel and at least one a right wheel are arranged rotatably on the associated axle; wherein
one of the axles is a brakeable axle, on which at least one brake device is arranged;
the other axle is a freely rotatable axle, on which no brake device is arranged; and wherein
the brake device is part of a braking system including
two meterable metering brake circuits; and
a nor-meterable parking brake circuit, wherein
each of two metering brake circuits has a metering brake device which is assignable to a wheel of the vehicle;
the two metering brake circuits have a common metering operating device, with which the two metering brake devices are operable simultaneously;
the metering operating device has a tandem brake cylinder, with two chambers which are each part of one of the metering brake circuits;
the parking brake circuit has two parking brake devices, which are each assignable to a wheel of the vehicle; and wherein
the parking brake circuit has a parking operating device with which the two parking brake devices are operable simultaneously.

12. The working vehicle as claimed in claim 11, wherein the two axles are connected to one another by a cardan shaft.
